(19) United States
(12) Patent Application Publication
(10) Pub. No.: US 2019/0151908 A1
(43) Pub. Date: May 23, 2019

(54) DEVICE FOR CONVEYING AND RETAINING A GLASS SHEET, PARTICULARLY IN A WASHING FACILITY

(71) Applicant: SAINT-GOBAIN GLASS FRANCE, Courbevoie (FR)

(72) Inventors: Vincent SAUVINET, GRENOBLE (FR); Malte LINN, AACHEN (DE); Jean-Jacques BRIS, BEY (FR)

(73) Assignee: Saint-Gobain Glass France, Courbevoie (FR)

(21) Appl. No.: 16/091,726

(22) PCT Filed: Apr. 5, 2017
(86) PCT No.: PCT/FR2017/050809

§ 371 Date: Oct. 5, 2018

(30) Foreign Application Priority Data
Apr. 6, 2016 (FR) 1653035

(51) Int. Cl. B08B 11/04; B65G 49/06

(52) U.S. Cl. CPC B08B 11/04; B65G 2201/022; B65G 2249/04; B65G 49/064

(57) ABSTRACT

A device for conveying and holding a sheet of glass, includes a conveyor and a holder configured to hold a sheet of glass in position, in particular in a horizontal position, wherein the device includes two spaced-apart and parallel lateral conveying systems, and a plurality of holding elements which are connected to each conveying system and are intended to support and locally clamp one or both faces of the sheet of glass.

The invention relates to a conveying and holding device for a sheet of glass, particularly in a horizontal position, and to a washing facility for sheets of glass comprising such a device.

The invention will be described more particularly with reference to an application of holding, during washing and drying, a sheet of glass intended to be conveyed through the washing and drying facility, without, however, being restricted thereto. It could apply to any application requiring a sheet of glass that is to be conveyed to be held, particularly in a (substantially) horizontal position, before it is integrated into its final end-use.

The invention applies more particularly to a sheet of curved glass, particularly for automotive applications, and of very small thickness, under 1.2 mm or even under 1.1 mm, without, however, being restricted thereto. It may apply to any sheet of planar or non-planar glass and to other types of vehicle or even other applications.

These days reducing the weight of motor vehicles is one of the avenues being explored by motor manufacturers in order in particular to reduce the consumption of fossil fuel of vehicles and therefore reduce the emissions of green house gases (CO₂).

Of all the constituent elements of a vehicle, the glazing is one of the components where weight reductions are being sought. One of the steps in reducing the weight of glazing is to reduce the thickness of the glass. Hence, glazings, in particular windshields are now being proposed in which the interior sheet of glass has a thickness of less than 1.2 mm or even less than 1.1 mm, such as of 0.7 mm or 0.55 mm or even 0.4 mm or 0.3 mm.

During the manufacture of laminated glazing, such as automotive glazing, the pair of curved glass sheets that are to be sandwiched together with a film of transparent plastic has to undergo a washing operation in order to avoid the presence of dust which would otherwise carry the risk of becoming entrapped within the laminate, generating visible defects that would not be admissible given the quality imposed in the automotive field, and would lead to the glazing being scrapped.

The cleaning of the curved sheets of glass is usually performed in washing tunnels, the sheets of glass passing one behind the other along a conveying device provided with two parallel and spaced-apart belts, being laid on said belts via their edge, at four points if the sheet of glass is symmetric, or at three points if its contour is asymmetric. Washing and drying are performed over the entire surface area of the two opposite faces of the sheet of glass and on the periphery thereof, by spraying pressurized water jets followed by pressurized air jets, the fact that the sheets of glass are positioned on edge allowing the entire surface and periphery of the sheets of glass to be cleaned.

However, sheets of glass with a thickness of the order of 1.4 mm or less subjected to the pressure of the water and air jets vibrate and deform, the amplitude of the vibrations being considerably increased as the thickness of the glass decreases. Specifically, the amplitude of vibration increases as much as the bending strength of the sheet of glass decreases, in proportion with the cube of the thickness of the sheet of glass. Thus, vibrations with an amplitude of the order of 20 mm are observed under the effect of the jets of drying air for a sheet of glass of thickness 1.4 mm, and reach respectively 40 mm and even 160 mm for glass with respective thicknesses of 1.1 mm and 0.7 mm. The vibrations cause the glass to knock against the blowing nozzles and generate significant shocks on the edge face of the glass resting on the conveyer belts giving rise to rupture initiators and causing the sheets of glass to break.

Water and air pressure adjustments and nozzle alignments do not make it possible to obtain satisfactory stability or to eliminate impacts for sheets of glass of very small thickness below 1.2 mm. There is too much breakage of the sheets of glass.

It is therefore an object of the invention to propose a device for conveying and holding a sheet of glass which obviates the aforementioned disadvantages while allowing the sheet of glass to be held firmly while it is being conveyed and, in the target application, while it is being washed, while at the same time guaranteeing optimal washing of the surface of the two faces of the sheet of glass, including the periphery of the sheet of glass. The device of the invention may advantageously be used in existing conveying and washing facilities.

According to the invention, the device for conveying and holding a sheet of glass, comprises conveying means and holding means which are intended to hold a sheet of glass in position, in particular in a (substantially) horizontal position, and is characterized in that it comprises two spaced-apart and parallel conveying systems referred to as lateral conveying systems, and extending longitudinally (in the conveying direction), and a plurality of holding elements which are connected to each conveying system and are intended to support and locally clamp (clamp) one (the underside face) or both faces of the sheet of glass.

The two lateral conveying systems are arranged in such a way as to be on either side and some distance away from the two lateral sides of the sheet glass.

What is meant by the lateral sides of the sheet of glass is the sides parallel to the direction of travel or of conveying of the sheet of glass and what is meant by upstream and downstream sides is the two opposite sides that are also substantially perpendicular to the lateral sides, upstream and downstream being understood with reference to the direction of travel.

The holding elements are intended to engage at the periphery of the two lateral sides of the sheet of glass.

The holding elements are secured to arms which are associated with the lateral conveying systems, extending substantially perpendicular to the latter.

The sheet of glass is therefore intended to be supported and held in position by the holding elements while at the same time being arranged between the two lateral conveying systems, some distance therefrom and with its opposite lateral sides substantially parallel to said systems.

Thus, the sheet of glass intended to be conveyed and which may, if need be, rest via its edge face at its upstream and downstream sides on a conventional central conveying system, is also held by one or both of its opposite faces, and is so locally, while at the same time remaining free of any frame surrounding its periphery, which means to say without the peripheral edge of the sheet of glass being enclosed in a structure. In addition, the holding elements arranged exclusively in a localized manner avoid contact over a continuous surface of the glass and allow optimal washing because of the limited nature of said area of contact.

The holding elements are intended to apply a clamping force to one or both faces of the glass, preventing any movement of amplitude of the sheet of glass when subjected to the influences of vibratory movements associated with the pressures of the water and air jets while it is being washed.

The device of the invention for conveying and holding a sheet of glass guarantees:
stabilized transportation for all sheets of glass whatever the geometry of the contour of said sheet;
protection of the edge face of the sheets of glass against any contact or shocks;
support on the lateral sides of the glazing forming the least possible impediment to access by the water and the air to the entirety of the surface and periphery of the sheets of glass.

In the remainder of the description, the terms “horizontal”, “vertical”, “upper”, “lower”, “top”, “bottom”, are to be understood to qualify elements of the device or of a sheet of glass when the device is resting fixedly on a horizontal plane and when the sheet of glass is associated with it also extending horizontally.

The term “height” when qualifying an element of the device is to be understood as meaning the vertical dimension, namely in a direction perpendicular to the horizontal plane containing the device.

The qualifier “lateral” is to be understood to mean a direction transverse (perpendicular) to the longitudinal conveying direction, namely direction of travel of the sheets of glass.

According to one feature, the holding elements support and clamp either, the supported face (underside face) of the sheet of glass using suction, or the two opposite faces of the sheet of glass, by gripping.

The holding elements engage against and/or near the two opposite lateral edges of the sheet of glass, particularly at a distance of at most 50 mm from each lateral edge of the sheet of glass toward the center thereof, and for preference of at most 20 mm or even of at most 10 mm. In practice, in particular for curved sheets of windshield glass, the distance is advantageously less than the width of the peripheral decorative black enamel (less than 20 mm); thus, any resulting defect there might be after washing as a result of the presence of the holding element will be hidden.

Each lateral conveying system comprises at least two holding elements (therefore at least four per sheet of glass) which are arranged a distance apart along the longitudinal axis of the system, in particular are distributed in a balanced manner (equal distances from one another when the number of elements is greater than two) so as to keep the sheet of glass uniform along each of its lateral sides. The number of elements is dependent on the dimensions of the sheet of glass. When each lateral conveying system comprises just two holding elements, these are preferably situated near the corners of the sheet of glass.

The distance between two adjacent holding elements of a lateral conveying system is preferably comprised between 100 and 800 mm and preferably 200 and 600 mm or 300 and 500 mm. The number and separation distance is adapted according to the dimensions of the sheet of glass and is reduced as far as possible so as to limit the time taken to adjust these holding supports to suit the dimensions of the series of sheets of glass that are to be processed.

Each holding element is intended to generate a local contact with the glass such as in the form of at least one point of contact or at least one line of contact.

What is meant by “point of contact” is a contact area of at most a few mm², particularly of at most 25 mm².

What is meant by “line of contact” is a contact area having a width of at most 3 mm. The length of the line is preferably comprised between 5 and 50 mm, in particular of the order of 30 mm.

According to one feature, a holding element, more particularly in the embodiment using gripping, generates a plurality of spaced-apart points of contact or of spaced-apart lines of contact so as to generate a contact area which, while admittedly localized, is however discontinuous so that after washing and removal from the holding device, the holding elements have left no trace on the glass that is visible to the naked eye.

According to the first embodiment using gripping, each holding element forms a gripper intended to press against the two opposite faces of the glass, sandwiching the thickness of the sheet of glass. Each gripper is intended to apply a controlled amount of clamping so as to avoid any rupture initiator or breakage of the glass.

Each gripper comprises two opposing jaws, one of the jaws being intended to support the sheet of glass (the underside face of the sheet of glass), while the other jaw is intended to press against the opposite face (upper face) of the sheet of glass with engagement by gripping.

The upper jaw is mobile and able to be raised vertically to bring the sheet of glass from vertically above the device and into a horizontal plane until it is resting on the lower jaw.

Advantageously, each gripper comprises an end stop, preferably made of a substantially elastic material, against which the peripheral lateral edge face of the sheet of glass can rest. The stop is situated on the inner side of the gripper, between the two jaws and laterally with respect thereto. The material of the stop is preferably the same as that of the jaws or protuberances.

For preference, each jaw of a gripper comprises a plurality of spaced-apart protuberances and water removal means. The protuberances, by being spaced apart, constitute point contacts (limiting the area of contact in order to optimize the washing) and allow water to flow and be removed.

According to the embodiment using suction, each holding element forms a suction cup against which the underside face of the glass, which is then intended to be clamped by suction, is intended to rest.

Each suction cup is connected to a reservoir that creates a vacuum. The vacuum created at the moment of the positioning of the glass on the suction cups and is maintained during the conveying time.

The suction cups may comprise elastic means of the soft foam type, positioned at the interface between the termination of the suction cup in contact with the glass and the body bearing the suction cup (the arm of the holding element), in order more easily to adapt to the geometry of the sheet of glass and guarantee intimate contact of the sheet of glass with the entirety of the facing contact surface of the suction cup and to make it easier to remove the sheet of glass after the drying operation.

Advantageously, the holding elements are removable or moveable and are adjustable in terms of position, along the associated lateral conveying system, and/or horizontally away from or toward the lateral conveying system, and/or vertically (namely height wise) and/or even in pivoting with respect to an axis parallel to the associated lateral conveying system, so as on the one hand to be positioned at the suitable points of engagement with the sheet of glass and thus allow the one same device to adapt to suit several peripheral dimensions and curvatures of the sheets of glass and, on the other hand, to fit into the (height wise) space separating the lower and upper water and air jet nozzles through which the sheet of glass is intended to circulate. The holding elements and/or the holding elements can be locked in position. The pivoting of the holding element with respect to the axis parallel to the lateral conveying system with which it is associated allows the holding element to be inclined about the axis of the arm supporting it and in the direction perpendicular to the conveying direction.

The arms associated with the lateral conveying systems are able at their free end to bear the holding elements and provide position adjustment thereof.

With regard to the pivoting, when the holding element is a gripper, this is, for example, mounted on a ball joint.

As a result, by adjusting the holding elements, one and the same device of the invention can be used whatever the dimensions and curvature of the sheets of glass.

Advantageously, the holding elements (terminations of the suction cups or jaws or protuberances of the grippers) are made of a plastics material that carries no risk of scratching the glass, for example with a shore D hardness of less than 90 and advantageously sufficiently soft, for example of soft rubber, or in particular with a shore A hardness comprised between 20 and 80, and able to adapt to the local curvature of the glass without applying too great a reaction force to the glass.

According to another feature, the holding elements can be actuated in an automated manner so as to assure the closure of the grippers during or after the positioning of the glass.

The invention also relates to an assembly comprising at least one central conveying system and one or more conveying and holding devices of the invention which are distant from one another in the direction transverse to the conveying, characterized in that the lateral conveying systems are arranged on either side of the central conveying system, the central conveying system and the lateral conveying systems being driven at the same speed.

The conveying devices are distant from one another in order to accommodate several sheets of glass, for preference the lateral conveying systems are individual for the various devices, which means to say that the lateral conveying systems extend continuously and have the holding elements distributed along their length at suitable points for the various sheets of glass that succeed one another.

The invention finally relates to a washing and drying facility comprising the aforementioned assembly or at least one conveying and holding device of the invention, particularly for cleaning sheets of glass, in particular curved glass for vehicle glazing such as of the windshield type.

For preference, the method of implementing the device of the invention is as follows, there generally being a central conveying system:
the position (in a horizontal plane) and height of the holding elements is adjusted with the device in a stationary position;
the sheet or sheets of glass are brought by automated means over the conveying and holding device (devices) so that they become lodged between and distant from the two lateral conveying systems;
each sheet of glass is deposited on the central conveying system at least at three support points according to the curvature via its upstream and downstream edges, the concave face in the case of a curved sheet of glass facing toward the conveyer (downward);
during this depositing of the sheet of glass, this sheet comes to rest against the holding elements. In the case of grippers, the sheet comes to rest against the lower jaws, then the upper jaws are closed in an automated manner to grip the sheet of glass. In the case of suction cups, a vacuum is created in order to clamp the glass by suction. The sheet of glass thus held can undergo the washing and drying steps.

The present invention is now described with the aid of examples which are purely illustrative and do not in any way restrict the scope of the invention, and on the basis of the attached illustrations in which:

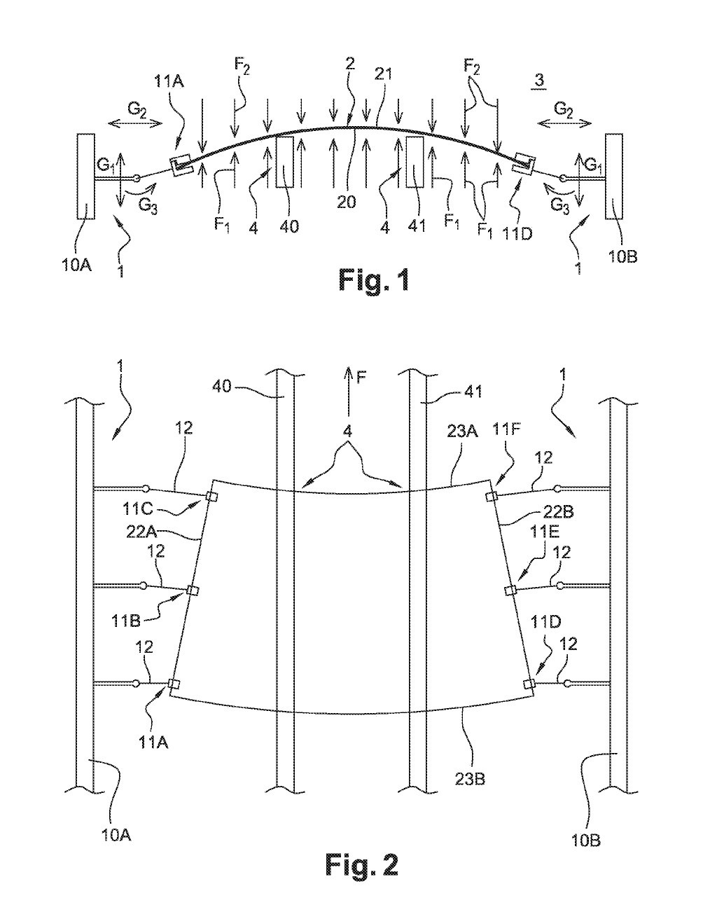

FIG. 1 depicts, in a washing facility, a schematic view in cross section of the conveying and holding device of the invention according to a first embodiment in the position of holding a sheet of glass, the view in cross section being a transverse section with respect to the longitudinal direction of conveying and situated in a vertical plane passing through the edge face of the downstream side of the sheet of glass;

FIG. 2 is a schematic plan view of the conveying and holding device of the invention of FIG. 1;

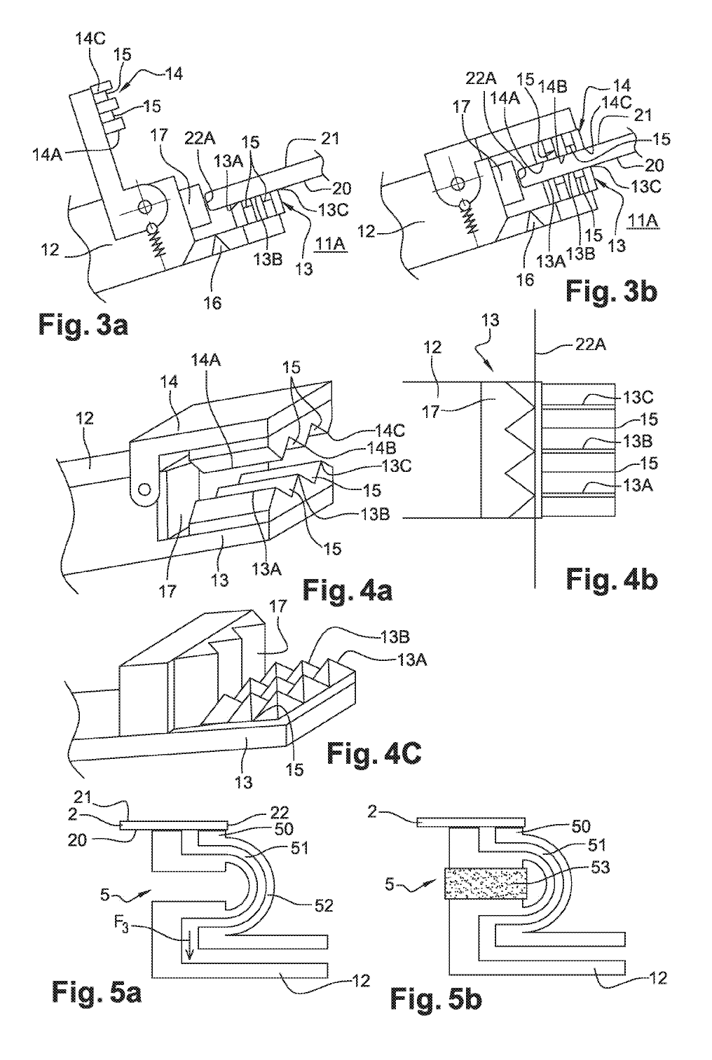

FIG. 3a is a detailed view in cross section of a holding element in the form of a gripper of FIG. 1, the gripper being in the open position;

FIG. 3b corresponds to FIG. 3a, the gripper being in the position of clamping against the sheet of glass;

FIG. 4a is a perspective view of one exemplary embodiment of a gripper in the closed position;

FIG. 4b illustrates a partial schematic view from above of a horizontal section on the plane containing the lower face of the sheet of glass, of the gripper of FIG. 4a associated with the sheet of glass;

FIG. 4c is another embodiment of a jaw of a gripper;

FIG. 5a is a detailed view in cross section of another embodiment of a holding element, in the form of a suction cup;

FIG. 5b is an alternative form of FIG. 5a.

The conveying and holding device 1 of the invention illustrated in FIGS. 1 and 2 has the purpose of holding a sheet of glass 2 in a substantially horizontal plane of conveying it or contributing to conveying it in a direction F and of holding it in position without any effect of amplitude or at the very least by minimizing these effects of amplitude when subjected to high vibrations on its two faces, in particular by water and air pressure jets.

FIG. 1 is a schematic illustration in cross section of a conveying and air-spraying facility 3 comprising the conveying and holding device 1 for conveying and holding a sheet of glass 2, comprising two parallel and spaced-apart conveying systems 10A and 10B arranged laterally with respect to the sheet of glass 2, and for preference a central conveyer 4 comprising two drive belts 40 and 41 and positioned between the two lateral conveying systems 10A and 10B and water or air pressure jets symbolized by the arrows F1 and F2 directed vertically respectively upward and downward. The lateral conveying systems 10A and 10B comprise holding elements 11A to 11F to support and clamp the sheet of glass.

In the embodiment of FIGS. 1 and 2, clamping is obtained by the gripping of the sheet of glass, the holding elements taking the form of grippers illustrated in FIGS. 3A to 4B.

According to another embodiment, gripping is performed by a suction on the underside face of the sheet of glass, the holding elements taking the form of a suction cup 5, as illustrated in FIGS. 5A and 5B.

The sheet of glass 2 has two opposite faces, a lower face 20 and an upper face 21, extending horizontally, the lower face 20 faces downward. The sheet of glass comprises two opposite lateral sides 22A and 22B which are parallel to the direction of travel, and two other sides referred to as the upstream side 23A and downstream side 23B, which are transverse to the lateral sides.

The sheet of glass 2 rests horizontally on the drive belts 40 and 41 via its edge face at its upstream 23A and downstream 23B sides (at least at three points depending on its curvature) while the conveying and holding device 1 guarantees that the sheet of glass 2 is held in this horizontal plane perpendicular to the jets.

The sheet of glass 2 in the example depicted is curved, the lower face 20 corresponding to the concave face 20. The concavity of the sheet of glass therefore faces downward, which means to say faces the central conveyer 4.

The holding elements 11A to 11F are applied locally against the glass, as illustrated in FIG. 2, near the opposite lateral edges 22A and 22B of the sheet of glass.

The sheet of glass 2 therefore rests in its middle part via its lower face 20 on the central conveyer 4, while the conveying and holding device 1 engages locally via the elements 11A to 11F with the periphery of the lateral sides of the sheet of glass, in particular by local clamping of the two opposite faces 20 and 21.

With reference to FIGS. 1 and 2, the plurality of elements 11A to 11F are associated with the lateral systems 10A and 10B via arms 12, particularly mobile arms, extending perpendicularly to said systems and facing one another.

The holding elements 11A to 11F are distributed over the length of the lateral conveying systems in a balanced manner at the region of the lateral edges 22A and 22B of the sheet of glass.

The arm 12 of each support is secured to a conveying system 10A, 10B, extending toward the opposite system, namely toward the central part of the sheet of glass, and perpendicular to the lateral edges 22A and 22B of the sheet of glass.

Each holding element 11A to 11F forms a system for holding and clamping the sheet of glass by engaging locally with at least the underside face 20 of the sheet of glass along limited contact areas, preferably in the manner of points of contact or lines of contact.

In the embodiment of FIGS. 1 and 2, this engagement of the holding elements is on the two opposite faces 20 and 21 of the sheets of glass and facing one another. Furthermore, it is achieved between 6 and 20 mm from the lateral edge 22A, 22B, respectively, of the sheet of glass.

The conveying systems with their holding elements are positioned by adjusting the holding elements before the start of the production run (the washing of sheets of glass), so as to support the shape of the sheets of glass (generally for windshields) of the coming production run. The holding elements 11A to 11F are able to be adjusted in terms of position:
in a horizontal plane perpendicular to the axis of travel of the sheet of glass (which is symbolized by the arrow G2 in FIG. 1),
height wise in a vertical plane (symbolized by the arrow G1 in FIG. 1), and
in terms of inclination in a vertical plane by being able to pivot about an axis that is horizontal and parallel to the longitudinal axis of the conveying systems and therefore of the travel (symbolized by the arrow G3 in FIG. 1).

In the embodiment of the elements of FIGS. 3a and 3b, each holding support forms a gripper and comprises two opposite jaws, a lower jaw 13 and an upper jaw 14, which are intended respectively to engage with the lower 20 and upper 21 faces of the sheet of glass 2.

Each jaw 13, 14 for preference comprises several lower protuberances 13A, 13B, 13C and upper protuberances 14A to 14C respectively intended to press via points of contact or a line of contact against the faces 20 and 21 respectively of the sheet of glass 2.

The lower jaw 13 is fixed while the upper jaw 14 is mobile, for example in pivoting in a vertical plane about an axis parallel to the associated edge of the frame. The pressing of the jaws against the faces of the glass produces clamping. The clamping is tailored so that it does not generate risks of breakage or rupture iniators.

Prior to clamping, the upper jaw 14 is opened by being moved vertically (FIG. 3a), which means to say transversally to the plane in which the sheet of glass 2 is intended to extend, so that the sheet of glass can be brought in from above the device and laid onto the holding elements 13A and 13B.

After the sheet of glass 2 has been applied against the lower protuberances 13A, 13B and 13C, the upper jaw 14 is swung toward the lower jaw 13 to sandwich the sheet of glass (FIG. 3b), the upper protuberances 14A to 14C coming to press against the upper face 21 of the sheet of glass. The lower protuberances 13A to 13C are arranged facing the respective upper protuberances 14A and 14C. The pressure applied by the upper jaw 14 is tailored to apply a clamping force of the order for example of one kilogram, which is sufficient to hold the glass in position with respect to the pressure of the water and air jets that the sheet of glass is going to experience, while at the same time avoiding a risk of breakage or rupture initiator.

Furthermore, the material of which the holding elements (protuberances) pressed against the glass are made is tailored to avoid the creation of rupture iniators when the glass experiences vibrations due to washing and to drying. For preference, the material is a plastics material which does not risk scratching the glass, for example with a shore D hardness of less than 90 and advantageously soft enough, for example being made of soft rubber, or in particular of a shore A hardness comprised between 20 and 80, and able to adapt to suit the local curvature of the glass without exerting too great a reaction force on the glass.

In order to minimize the areas of contact with the glass to optimize the surface area washed, the protuberances 13A to 13C, 14A to 14C have bearing/contact surfaces which engage in the manner of lines of contact (when viewed from above in the cross section of FIG. 4b).

The holding elements may extend lengthwise perpendicular or indeed parallel to the lateral sides 22A, 22B of the sheet of glass as described in FIGS. 3a and 4b and form spaced-apart lines of contact as illustrated schematically in FIG. 4b which shows the lower protuberances 13A to 13C pressed against the glass (the upper part of the jaw is not visible in this cross-sectional view). The lines are spaced by 6 mm for example, and the width of each line is 1 mm.

The protuberances 13A to 13C and 14A to 14C are derived for example from notched or wavy surfaces (FIG. 4a) affording an alternation of ribs (protuberances) and voids 14 in alternation and parallel. In the alternative form of FIG. 4C, the protuberances form pyramids the truncated or non-truncated tips of which are intended to engage with the glass. Other geometries are conceivable, such as spheres or half-spheres even.

Each jaw 13, 14 is designed to remove the water during the washing and drying. The jaws comprise removal grooves 15 between the protuberances and in the lower part of the lower jaw a removal spout 16, substantially facing the free lateral edge 22A (22B) of the sheet of glass.

Moreover, each holding element comprises, between and laterally with respect to the two jaws 13 and 14 and on the interior side of the gripper, an end stop 17, preferably made of a substantially elastic material, against which the free peripheral edge 22A of the sheet of glass can rest.

The actuation of the conveying systems 10A and 10B and the holding elements 11A to 11F of the device of the invention are performed in an automated manner.

FIGS. 5a and 5b illustrate the second alternative form of embodiment of a holding and clamping element in the form of a suction cup 5.

The support involving a suction cup 5 engages only with the underside face 20 of the sheet of glass 2.

The suction cup 5 comprises a termination 50 intended to have the underside face 20 of the sheet of glass 2 resting against it, which sheet is brought in as for the embodiment with gripper, vertically over the lateral conveying systems 10A and 10B.

Like with the elements 11A to 11F, a plurality of suction cup elements 5 is distributed along the length of the lateral sides 22A and 22B of the sheet of glass, this being some distance from the lateral conveying systems via the support arms 12.

The suction cup 5 comprises an air suction cup 51 which is connected to the termination 50 of the suction cup and opens to the outside facing the underside face 20 of the sheet of glass. This suction duct 51 is housed in a flexible pipe 52 connecting the termination 50 to the arm 12. The suction duct 51 is then extended into the arm 12 and connected to a vacuum pump supported by the lateral conveying systems.

In the position for clamping of the sheet of glass a vacuum is imposed in the duct 51, sucking air in the direction of the arrow F3 and fixing the underside face 20 of the sheet glass by suction, while at the same time controlling the pressure in order to avoid any risk of breakage or rupture intiator in the glass. The vacuum is created in such a way that a residual pressure at the interface between the glass and suction cup is preferably comprised between 0.1 and 1 bar, for example of the order of 0.5 bar.

In the alternative form of FIG. 5b, the suction cup 5 comprises, at the interface between the termination 50 and the arm 12, elastic means 53, such as soft foam so as to adapt more easily to the geometry of the sheet of glass and guarantee close application of the sheet of glass facing the entirety of the contact area of the suction cup, and so as to ease removal of the sheet of glass from the device after the drying operation.

The contact surface of the suction cup head 50 has a diameter for example between 10 and 50 mm, a central hole of 3 mm being enough to create the vacuum. This area of contact is very small and remains localized to a few points with respect to the entirety of the surface area of the sheet of glass. This second embodiment with suction cup elements is rather reserved for sheets of glass intended to constitute the sheet of glass referred to as the inner sheet in a laminated glazing, namely on the concave side in the case of a windshield, given that the part of the glass in contact with the suction cup will not in this case ultimately be the one in contact with the plastic interlayer.

1. A device for conveying and holding a sheet of glass, comprising a conveyor and a holder configured to hold a sheet of glass in position wherein the device comprises two spaced-apart and parallel lateral conveying systems, and a plurality of holding elements which are connected to each conveying system and are configured to support and locally clamp one or both faces of the sheet of glass.

2. The device as claimed in claim 1, wherein the holding elements support and clamp either, the supported face of the sheet of glass using suction, or the two opposite faces of the sheet of glass, by gripping.

3. The device as claimed in claim 1, wherein the holding elements are secured to arms which are associated with the lateral conveying systems, extending substantially perpendicular to the latter.

4. The device as claimed in claim 1, wherein each lateral conveying system comprises at least two holding elements which are arranged a distance apart along a longitudinal axis of the system.

5. The device as claimed in claim 1, wherein each holding element is intended to generate a local contact with the glass.

6. The device as claimed in claim 1, wherein the holding elements engage against and/or near the two opposite lateral edges of the sheet of glass.

7. The device as claimed in claim 1, wherein each holding element forms a gripper comprising two opposing jaws, one of the jaws being intended to support the sheet of glass, while the other jaw is mobile and intended to engage by gripping with the opposite face of the sheet of glass.

8. The device as claimed in claim 7, wherein each jaw of a gripper comprises a plurality of spaced-apart protuberances and a water removal device.

9. The device as claimed in claim 1, wherein each holding element forms a suction cup against which the underside face of the glass, which is intended to be clamped by suction, is intended to rest, the suction cup being connected to a reservoir that creates a vacuum.

10. The device as claimed in claim 1, wherein the holding elements are removable or moveable and are adjustable in position, along the associated lateral conveying system, and/or horizontally away from or toward the lateral conveying system, and/or vertically and/or in pivoting with respect to an axis parallel to the associated lateral conveying system.

11. The device as claimed in claim 1, wherein the holding elements are made of a plastics material.

12. The device as claimed in claim 1, wherein the holding elements are actuatable in an automated manner.

13. An assembly comprising at least one central conveying system and one or more conveying and holding devices which are distant in a conveying direction, wherein the lateral conveying systems are arranged on either side of the central conveying system, the central conveying system and the lateral conveying systems being driven at a same speed.

14. A washing and drying facility comprising at least one conveying and holding device as claimed in claim 1 for cleaning sheets of glass for vehicle glazing.

15. The device as claimed in claim 1, wherein the holder is configured to hold the sheet of glass a horizontal position.

16. The device as claimed in claim 5, wherein the local contact with the glass is in the form of at least one point of contact or at least one line of contact.

17. The device as claimed in claim 16, wherein a contact area is at most 25 mm² or the line of contact has a width of at most 3 mm.
